(19) United States
(12) Patent Application Publication
(10) Pub. No.: US 2012/0182588 A1
(43) Pub. Date: Jul. 19, 2012

(54) DISTRIBUTED IMAGE ACQUISITION FOR POSTAL PROCESSING

(76) Inventors: John J. Mampe, Palm Coast, FL (US); Stanley W. Sipe, Mansfield, TX (US)

(21) Appl. No.: 13/006,497

(22) Filed: Jan. 14, 2011

(51) Int. Cl. G06K 15/02; G06K 9/00

(52) U.S. Cl. 358/3.28; 382/101; 382/102

(57) ABSTRACT

Mail processing methods and systems. A method includes receiving a mailpiece at a local system and scanning the mailpiece by the local system to produce an image. The method can include receiving payment information from the customer by the local system for mailing the mailpiece. The method includes applying an identification code to the mailpiece by the local system, and after the mailpiece is delivered to a central processing facility, processing the mailpiece, using the image, by a central server system at the central processing facility. Related apparatuses and systems are discussed.

### TECHNICAL FIELD

The present disclosure is directed, in general, to mail and parcel processing techniques.

### BACKGROUND OF THE DISCLOSURE

Improved and more efficient postal processing systems are desirable.

### SUMMARY OF THE DISCLOSURE

Various disclosed embodiments include mail processing methods and systems. A method includes a distributed system for receiving a mailpiece at a local system and scanning the mailpiece manually or by the local system to produce an image. The method can include receiving payment information from the customer by the local system for mailing the mailpiece. The method includes applying an identification code to the mailpiece by the local system, and after the mailpiece is delivered to a central processing facility, processing the mailpiece, using the image, by a central server system at the central processing facility.

Another embodiment includes a low volume mail processing local system apparatus. The apparatus has a transport mechanism configured to receive and transport a mailpiece from a customer or postal operator for processing by the local system. The apparatus includes an imaging device configured to create an image of the mailpiece and a first printing device for applying an identification code to the mailpiece. The apparatus includes a communications interface configured transmit the image of the mailpiece to a central server system.

Another embodiment includes mail processing system including a central server system at a central processing facility and a plurality of mail processing local system apparatuses, each in a different geographic location, configured to communicate with the central server system. The structure and operation of each mail processing local system apparatus is described.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a simplified block diagram in accordance with disclosed embodiments;

FIGS. 3-6 depict flowcharts of processes in accordance with disclosed embodiments; and

FIG. 7 depicts a block diagram of an apparatus in accordance with disclosed embodiments.

### DETAILED DESCRIPTION

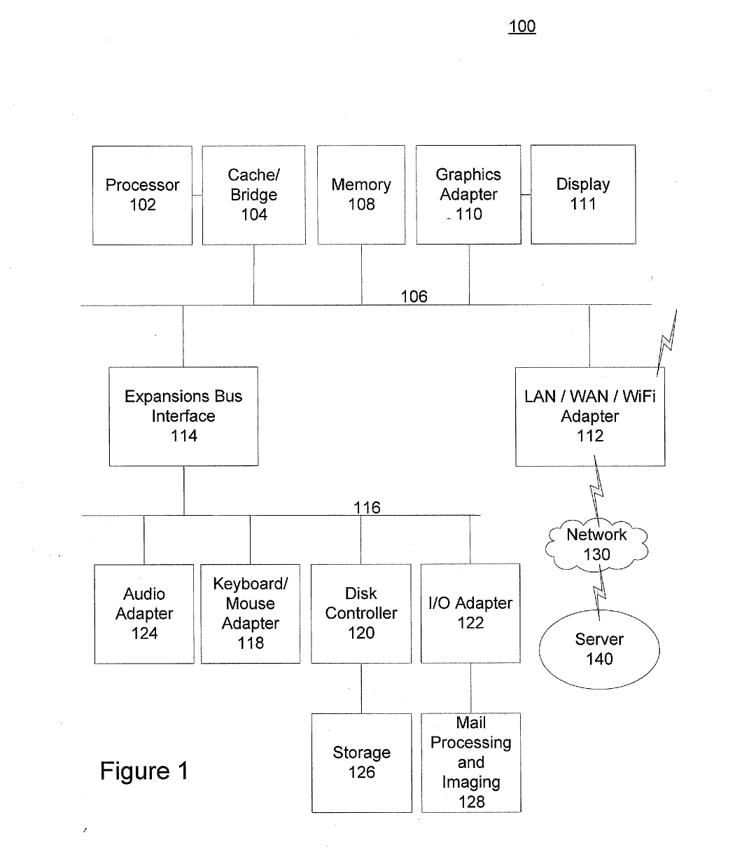

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Current postal address processing has concentrated on the processing of mail items on high speed mail processing equipment. In the case of letter mail, items mailed by the general public at their local post office are presented to the window clerk or in a collection box at the local post office. Those presented to the window clerk are normally presented because additional postal services are requested or the weight and type of service for the item are unknown or unclear to the person presenting the mail item. Other items mailed from homes or in collection boxes are collected by carriers or special mail collection routes, and those items are brought to the local post office. At selected periods of the day, typically early afternoon and early evening, the mail items are aggregated from the various collection routes and transferred via truck from the local post office to the centralized processing facility. At the facility, the larger packages are routed to parcel sorting equipment. The letter sized and larger letters, referred to as flat items or flats, are routed to automated systems that preprocess the items into two mail streams—letters and flats. The letters typically continue on through a machine that automatically orients the items according to the indicia, applies an identification code and then images the address surface. The image is then processed via OCR technology. It is at the moment that the mail item is uniquely imaged and/or an identification code is applied that the postal service data processing system recognizes that a unique item is in existence and the time of the entry automatically associated with the item. A percentage of the mail items that are imaged cannot be resolved to the finest level to enable them to be processed to the specific delivery point required for automated carrier sequencing of the mail pieces.

These images are sent to video coding operators to enable the images to be keyed and resolved by additional address directory searching. This keying operation occurs asynchronously as different images take differing amounts of time and the volume of images and available number of keying personnel may result the processing being delayed for a significant period of time. In this process, the physical mail items are normally placed in trays and set aside for a predetermined time period, typically one half hour, until all results should have been resolved. At that time, the mail pieces are reprocessed on a machine that reads the pre-printed identification code, queries the data base for the finalized ZIP Code result, and then prints that result in bar code form on the mail item. While the time for processing the items within the central processing plant may only be a few hours, the actual time from the deposit of the physical mail item into the postal service's custody may be many hours or a day.

Subsequent processing and carrier sequencing is accomplished on automated equipment that reads the bar code and/or the back-up identification code. The identification code with its associated database of results may be used in lieu of the bar coded delivery point bar code if the results have been distributed nationwide.

Disclosed embodiments include systems and methods that provide distributed image processing capability at the local acceptance points, including small post offices and mail centers each at a different geographical location, and network those to a central processing facility. By doing so, there is improved mail processing efficiency. According to disclosed embodiments, imaging and address processing can occur during the latency time that the mailpiece sits or is in transport to the processing facility. In various embodiments, all mail results processed at local acceptance points, whether from address recognition systems or manual keying, will be available to be applied to mail pieces on the first piece of automation upon which they are processed at the central processing facility. A post office, mail processing center, or kiosk described herein are all intended to refer to any private or governmentally controlled system or storefront that processes mail pieces and other packages for shipment.

FIG. 1 depicts a block diagram of a data processing system in which an embodiment can be implemented, for example as one of the local or central systems or servers described below, and can be configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

I/O adapter 122 can be connected to mail processing and imaging devices 128, as described herein, to image, scan, transport, label, address process, sort, and otherwise processes the mail pieces in accordance with the various embodiments described herein.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. LAN/WAN/Wireless adapter 112 can also communicate with packages as described herein, and perform other data processing system or server processes described herein. Data processing system 100 can communicate over network 130 with one or more server systems 140, which are also not part of data processing system 100, but can be implemented, for example, as separate data processing systems 100. A server system 140 can be, for example, a central server system at a central mail processing facility.

Various disclosed embodiment include the automated processing of images, and in particular the scanning and processing images from a plurality of semi-automatic scanning stations. This is performed as part of other computer assisted manual processing functions or the input of individual postal customer and the aggregation of those images after data transmittal to a centralized distribution point.

Disclosed embodiments include a method of decentralizing the image acquisition and processing an image of a mail item. In place of centralized processing, these processes are performed concurrently with other transactions at a point of sale window terminal, during other data entry operations, or upon the deposit of the mail item into the postal system. The local system, as used herein, refers to the system or systems at the local post office, mail processing store, or other local unit that receives mail from customers for delivery. Mail and mailpiece is intended to refer to any letter, flat, or parcel to be delivered by the USPS or private courier. The local system and the central server described herein can each be implemented using one or more data processing systems 100, modified where necessary to include additional conventional mail processing hardware, and can communicate with each other over a network.

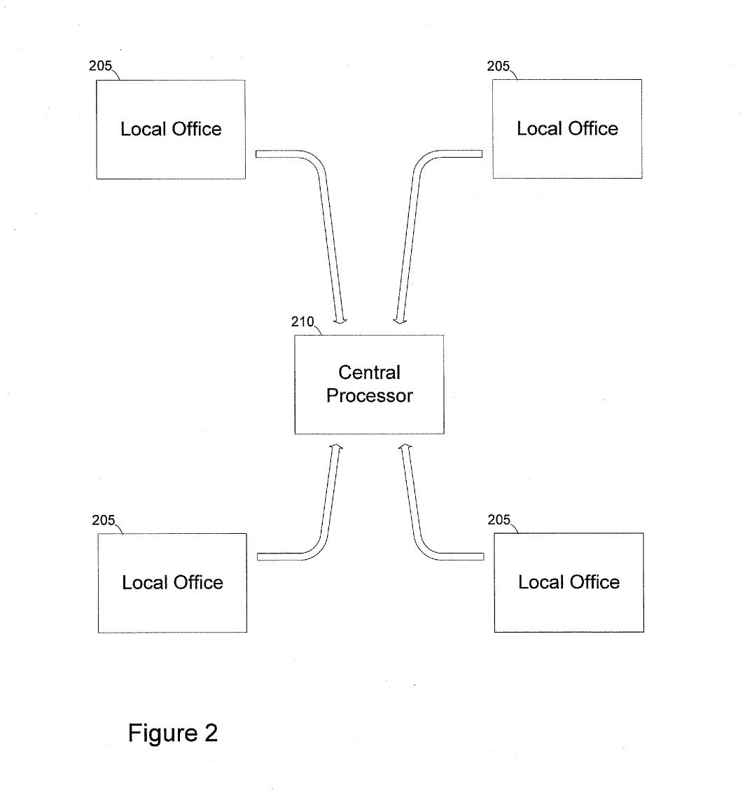

FIG. 2 depicts a simplified block diagram in accordance with disclosed embodiments. Shown here are a plurality of local post offices 205 and a central processing facility 210. As described herein, each of the local post offices 205 perform initial imaging and other processing of mail pieces, and transmit the captured data to the central processing facility 210. The mail pieces are physically transferred from each of the local post offices 205 to the central processing facility 210. In various embodiments, the local post offices 205 can include USPS post offices, privately operated mailing centers and similar retail operations, and self-service kiosks configured to perform the processes described herein.

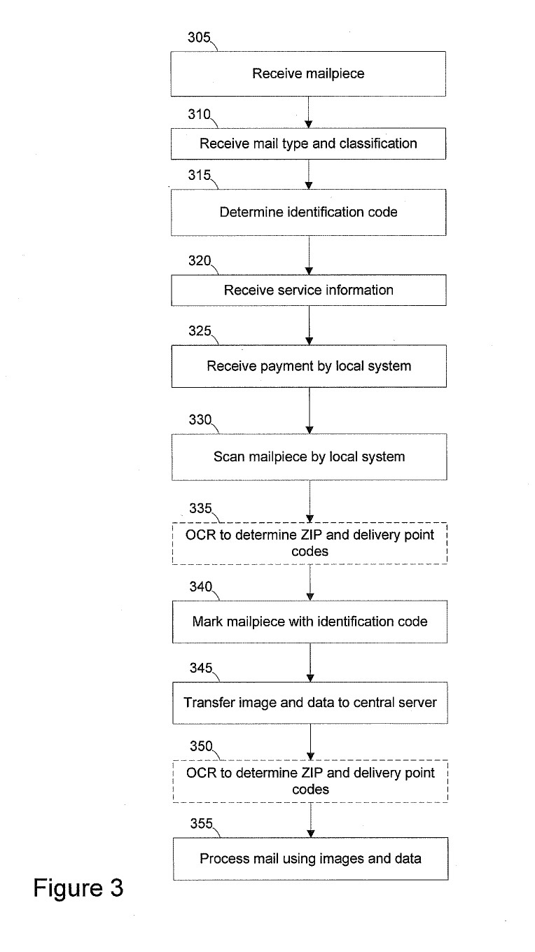

FIG. 3 depicts a flowchart of a process in accordance with disclosed embodiments. In the processes described herein, various steps may be omitted, repeated, performed sequentially or concurrently, or performed in a different order, or performed as part of separately-described processes, unless otherwise specified. Some steps are indicated as performed by a customer service agent, but could alternately be performed by a customer user in a self-service environment. Various embodiments can include combining various steps from different exemplary processes disclosed herein.

A mailpiece is received from a postal customer (step 305), for example at a post office, private mail service center, or kiosk, either by a customer service agent or by an apparatus as described herein.

The point-of-sale (POS) or other local system receives the mail type and service classification of the mailpiece as determined by the customer service agent (step 310), and the local system determines the next available identification code for the particular mail type and service classification (step 315).

In some cases, the POS system receives information related to the customer's desired service, which can be based upon the mail type (letter, flat, or parcel, for example), mailpiece weight, and service classification (step 320), as entered by the customer service agent or other user.

The POS system can receive payment information from the customer (step 325). This payment information can be entered directly by the customer, for example by entering credit or debit card information or inserting cash or coins at a mailing kiosk or self-service local system implementation. Alternately, the payment information can be entered by an operator of the POS system, such as a clerk at a local mailing center, based on the payment provided by the customer. In this way, the local system receives the mailpiece, payment for the mailing (according to the mail piece type, requested service, and any other relevant information as described herein), and performs the local-system processing as described herein.

Receiving payment information, as used herein, can also include verifying that payment has already been made, such as by verifying that postage is affixed to the mailpiece or has been received from the customer; in addition to or as an alternative to directly receiving the payment information from the customer or clerk. Verifying affixed postage can be implemented, for example, by a simple stamp presence detector or higher level verification as known to those of skill in the art.

The system scans the mailpiece to produce an image of the mailpiece (step 330). In various embodiments, this process is performed when the mailpiece is received by the customer service agent, who places the item on a surface, such as the postal scale, over which is stationed an imaging device as described herein. The system auto-focuses the imaging device and obtains the image of the mail item.

In some cases, the local system optionally performs an optical character recognition (OCR) process to determine the ZIP Code and delivery point bar code for the mailpiece (step 335).

The local system prints the identification code to be applied based on the symbology used for the particular mail type and uses this to mark the mailpiece (step 340). This step can also optionally include printing the indicia information and delivery point bar code or unified delivery point and identification data. The indicia and identification code is applied to or printed directly on the mailpiece and it is placed in an appropriate tray or receptacle. Different identification code symbologies can be generated and accommodated depending upon the requirements of the downstream mail processing operations.

The local system transfers the image, with its associated identification code data and any ancillary data obtained as a byproduct of the weighting and customer requested service for the mail item, to the central server at the centralized processing plant, along with any optionally derived OCR and delivery point data (step 345). The mailpiece is placed in an appropriate tray or container depending upon the shape of the mailpiece, maintaining orientation of the mailpiece as required, and the mailpieces are dispatched to the centralized processing facility. Any of the other data related to the mailpiece can be associated with the identification code, which is preferably unique to the mailpiece.

The local system in various embodiments, can also determine its own geographic location as a geographic reference, associate the geographic reference with the identification code, and transmit these to the central processing facility or centralized postal facility. This geographic reference can be used to determine where the mailpiece entered the processing stream, and in particular can be used to trace where contraband, prohibited items, or other material was deposited for mailing.

The central server at the centralized postal facility processes the image and associated data upon data receipt using OCR/address interpretation technology and derives the delivery bar code data for each piece (step 350), if this step was not or could not be performed by the local system. In cases where this step cannot be accomplished by OCR/address interpretation technology, the image is transferred to video coding operators to key sufficient data to resolve the image. The resolved delivery point bar code information for each piece is stored to be accessed by the central server, any bar code sorting machines, and for any other purposes.

Upon receipt of the pre-imaged mail pieces at the centralized postal facility, the mailpieces are routed to the appropriate identification code reading and optionally ZIP Code bar code printing machine(s) using the images and data, bypassing the collection mail processing equipment (step 355), since those processes have already been performed by the local systems. Because the transmitted images and data typically arrive at the central server before the physical mailpieces arrive, disclosed embodiments achieve increased efficiency by performing electronic processing at the distributed local systems or at the central system while the mailpieces are in transit.

Various processes described herein can also be integrated into a postal kiosk wherein the customer provides the input data, and the camera imaging device can be fixed above a surface where the item is weighed or integrated after the slot in which a mail piece is deposited to scan the mailpiece as it is inserted.

The method of processing individual mail items submitted by postal customer at the window enables letters, flats and parcels to each receive a different bar code symbology as is typically used on each mail type. As unified bar code symbology is adopted and utilized across multiple mail types, the determination of the identification code is simplified.

Disclosed embodiments also include methods to image and apply identification codes to the larger volumes of mail received in the office from the returning carriers and collection routes.

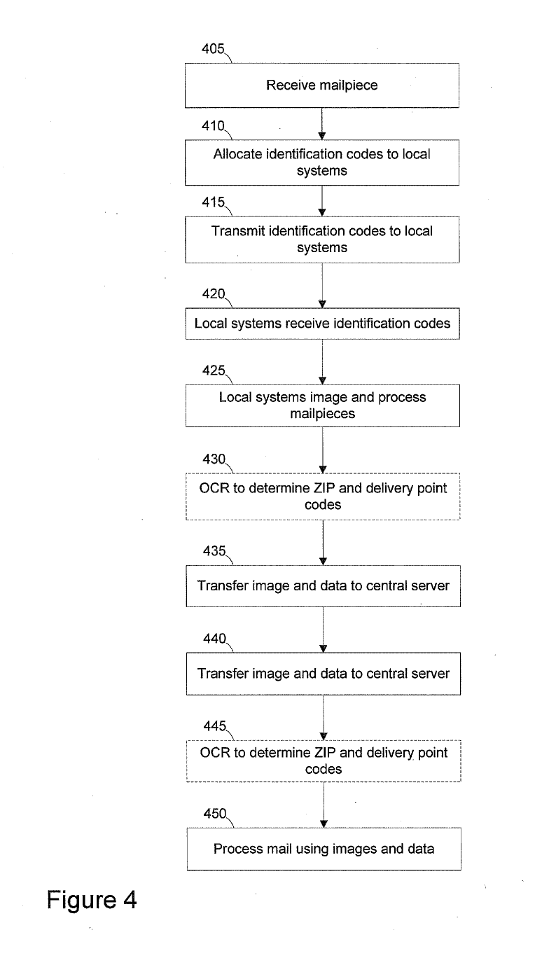

FIG. 4 depicts a flowchart of a process in accordance with disclosed embodiments. In such a process, carriers receive mail from customers or collection boxes while delivering their mail and, optionally, maintaining orientation of the received items as they place them in a satchel or tray(s) (step 405).

At the central processing facility, if the code-space is insufficient to allocate unique numbers to a distributed population of devices, the central server parses the code symbology as appropriate to allocate a block of codes normally assigned to one high speed processing machine to a larger number of low speed processing machines (step 410). Such parsing is done by allocating one range of codes to multiple sub-groups of numbers depending upon the symbology assigned, or alternatively, combining fields within the code space into an larger group of fields each comprising a more limited number space.

The central server transmits the appropriate more limited number range of codes to each of the distributed post offices within its area of control (step 415).

Each local system downloads the appropriate more limited number range to image mail pieces and apply identification codes (step 420).

Upon the receipt of the mail at the local post office, the local system singulates, transports, images, applies an identification code to, and stacks the mailpieces (step 425). If the orientation was optionally maintained, the device need only image one surface.

The local system optionally performs OCR processing on the mailpieces (step 430).

The local system transfers the images, identification code data, and optional OCR data to the central server at the centralized processing plant (step 435). The mailpieces are sent to and received at the centralized processing facility.

The central server processes the image and associated data upon receipt using OCR/address interpretation technology and derives the delivery bar code data for each piece (step 440), if this was not or could not be performed at the local systems. If delivery point resolution is not able to be accomplished by OCR/address interpretation technology, the image is transmitted to video coding operators to key sufficient data to resolve the image. The resolved delivery point bar code information for each piece is stored to be accessed by the central server, any bar code sorting machines, and for any other purposes.

Upon receipt of the pre-imaged mail pieces at the centralized postal facility, the mailpieces are routed to the appropriate identification code reading and optionally ZIP Code bar code printing machine(s) using the images and data, bypassing the collection mail processing equipment (step 450), since those processes have already been performed by the local systems.

Various embodiments also include methods for processing the randomized mail that is retrieved from collection boxes. The first is to simply send this to the centralized processing facility to utilize its highly automated equipment. If, however, the decentralized post office is of sufficient distance from the central processing site, or has a significant volume of mail to justify local image acquisition and where the benefits of latency argue that early processing of mail images would improve overall system productivity, the mail may be processed at the local post office though a local system that singulates, transports, orients, image lifts, applies identification codes, and stacks the mail pieces.

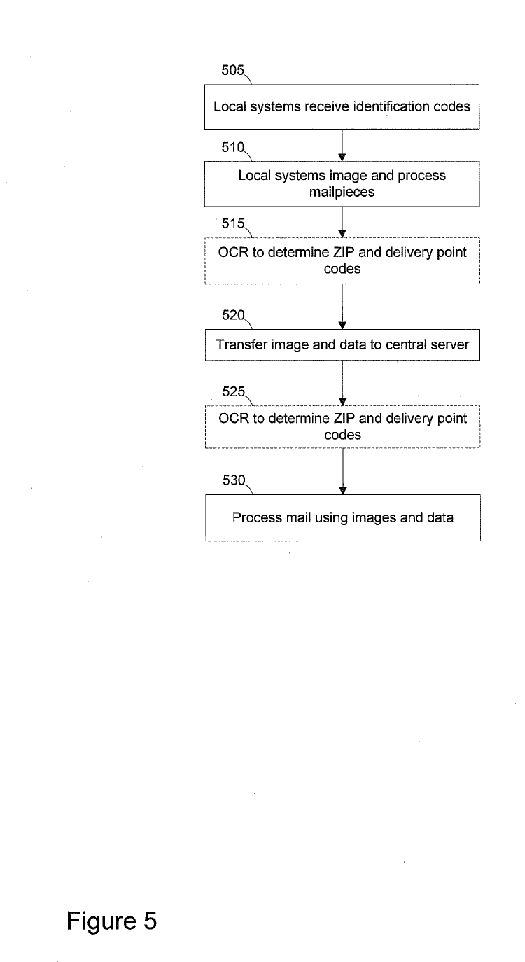

FIG. 5 depicts a flowchart of a process in accordance with disclosed embodiments.

The local system receives a range of identification codes to be applied to mailpieces (step 505).

Upon the receipt of the mail at the local post office, the local system singulates, transports, images, applies an identification code to, and stacks the mailpieces (step 510). If the orientation was optionally maintained, the device need only image one surface.

The local system optionally performs OCR processing on the mailpieces (step 515) to determine the appropriate delivery point bar code and other information, and optionally applies such code depending upon the design of the local system.

The local system transmits the images with the associated identification code data and other data for each mailpiece to the central server at the centralized postal facility (step 520). The mailpieces are transferred to the central postal facility, preferably in trays or other containers indicating that the mailpieces have been previously imaged.

The central server processes the image and associated data upon receipt using OCR/address interpretation technology and derives the delivery bar code data for each piece (step 525), if these processes were not or could not be performed at the local systems. If delivery point resolution is not able to be accomplished by OCR/address interpretation technology, the image is transmitted to video coding operators to key sufficient data to resolve the image. The resolved delivery point bar code information for each piece is stored to be accessed by the central server, any bar code sorting machines, and for any other purposes.

Upon receipt of the pre-imaged mail pieces at the centralized postal facility, the mailpieces are routed to the appropriate identification code reading and optionally ZIP Code bar code printing machine(s) using the images and data, bypassing the collection mail processing equipment (step 30), since those processes have already been performed by the local systems.

Different symbologies can be used for different product types. Parcels, for example, can have a bar code with large symbols and somewhat limited data. These codes are designed for high readability with laser scanning devices. Letter and flat mail, use bar, half-bar or four-state codes for ZIP Code data that are designed to be printed by mailers or ink jet printers at high production rates. The codes are nominally the height of a line of printed text and as such can be printed by mailers as the address block is being printed on a document or label. Additional data in a four-state bar code enable additional data to be applied that uniquely identifies the mail item in addition to containing the ZIP Code data. The USPS uses a bar/no-bar code to embed identification code data for letter mail, and a four state visible code to embed data for flat mail items and customer prepared mail. Each code contains data that identifies the machine, day of month and time with differing increment resolution, and item number information. The item number information is nominally designed to be a multiple of the number of items that can be processed on a single transport during a time period.

According to various embodiments described herein, one method of parsing data is to divide the time and number space assigned to a single machine, such as the central server, into many subgroups of numbers that more closely reflect the processing speed of many local systems, such as much lower-production machines or individual point of sale terminals. In such a case, the numbers assigned to a single machine (nominally 32,000 items per half hour increment for example) can be parsed into 320 machines each with a processing capability of 100 items in a half hour, or 32 machines that can process 1000 items per half hour. The actual parsing will depend upon the productivity of devices that are designed for the image acquisition, or the productivity of window clerks or other operators processing large transactions at the window.

In some embodiments, the postal customer could place a mailpiece (letter, flat, or parcel) on a scale over which is positioned an autofocus camera.

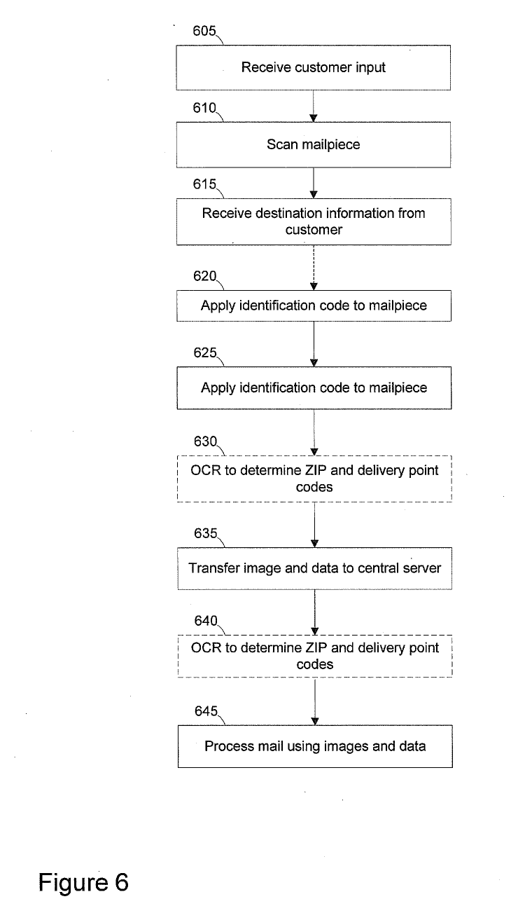

FIG. 6 depicts a flowchart of a process in accordance with disclosed embodiments.

The local system receives information via data input from the customer that describes which services are desired (step 605), including receiving the customer's selection of the type of article: letter, flat or parcel. The customer places the item under an imaging device of the local system or otherwise receives it.

The local system obtains an image of the surface of the mailpiece containing the destination address (step 610) by scanning the mailpiece or otherwise, and can also obtain the weight of the mail piece.

The system optionally receives the destination city, state and/or country information or ZIP Code data (step 615), such as from a customer input, and can also receive other data, such as any special service information requested for the item, and can determine the geographic location of the local system.

The local system can receive payment information from the customer (step 620). This payment information can be entered directly by the customer, for example by entering credit or debit card information or inserting cash or coins at a mailing kiosk or self-service local system implementation. Alternately, the payment information can be entered by an operator of the local system, such as a clerk at a local mailing center, based on the payment provided by the customer. In this way, the local system receives the mailpiece, payment for the mailing (according to the mail piece type, requested service, and any other relevant information as described herein), and performs the local-system processing as described herein.

The local system calculates the next available identification code and applies the code to the mailpiece, such as by directly printing such code on the mail piece or by printing the code on a label to be affixed to the mail piece (step 625). The data for such identification code can be parsed as described herein. Any data or images related to the mailpiece or the local system can be then associated with the identification code.

The local system can optionally process the image data at the local post office facility with address recognition software and OCR processes to further resolve ZIP Code data to the finest level (step 630). The ZIP Code data can be made available to the customer for confirmation or by printing such data on a receipt.

The local system transfers the image with its associated identification code data to the central server at the centralized processing plant, along with any optionally derived OCR and delivery point data and any information entered by the customer (step 635). The mailpieces are transferred to the central postal facility, preferably in trays or other containers indicating that the mailpieces have been previously imaged, and segregated by shape or size as appropriate.

The central server processes the image and associated data upon receipt using OCR/address interpretation technology and derives the delivery bar code data for each piece (step 640), if this was not previously performed. If delivery point resolution is not able to be accomplished by OCR/address interpretation technology, the image is transmitted to video coding operators to key sufficient data to resolve the image. The resolved delivery point bar code information for each piece is stored to be accessed by the central server, any bar code sorting machines, and for any other purposes.

Upon receipt of the pre-imaged mail pieces at the centralized postal facility, the mailpieces are routed to the appropriate identification code reading and optionally ZIP Code bar code printing machine(s), bypassing the collection mail processing equipment (step 645), since those processes have already been performed by the local systems.

Various embodiments include a mail processing apparatus that can be used by presort bureaus and other organizations that consolidate and presort mail prior to depositing with the postal organization thereby earning presort discounts for the value added work. Such an apparatus could be rented or leased to grocery stores or other establishments, where the public could bring mail pieces and obtain a nominal rebate on postage at a check out counter when they purchased other items.

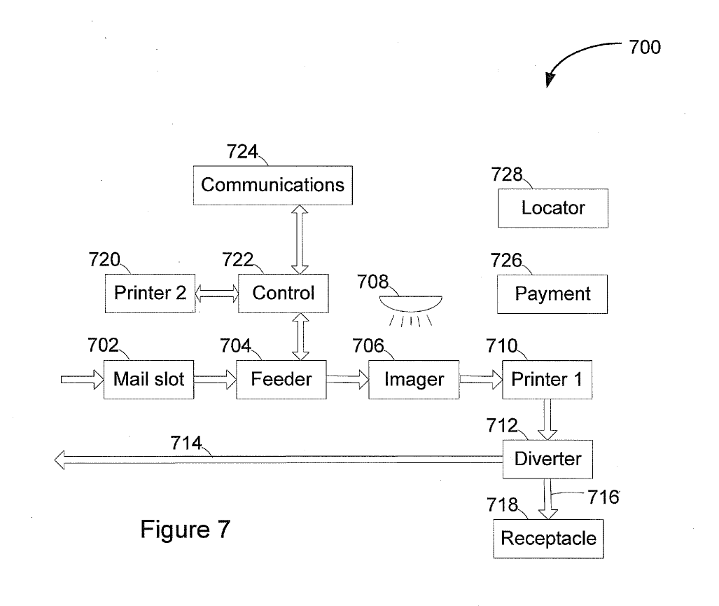

FIG. 7 depicts a block diagram of an apparatus 700 in accordance with disclosed embodiments. Such an apparatus can be implemented by using a data processing system 100 as the controller and for processing of the data as described. The apparatus 700 can be configured to perform processes as described herein, as the local system.

Apparatus 700 includes a mail slot 702 or other orifice through which a mailpiece would be received. The input orifice 702 passes the mailpiece to a transport mechanism such as a friction feed roller 704 that can convey the item at a constant velocity past an imaging device 706. The imaging device 706 is capable of imaging at least the front surface of the mail piece.

Apparatus 700 also includes an illumination source 708 to illuminate the area being imaged, a first printing device 710 such as an ink jet print head capable of printing the identification code on the mailpiece. Apparatus 700 includes a return path 714 for items inserted incorrectly to return such items to the customer.

Apparatus 700 includes a diverter gate 712 to switch between the return path 714 and the normal path 716, and a receptacle 718 to stack the items that have been successfully imaged.

Apparatus 700 can include a second printing device 722 that prints a confirmation to the customer, such as of the number of items being deposited. Apparatus 700 includes a control system 722 that can be implemented as a data processing system 100, to perform processes as described herein, connected to each of the other components (most connections omitted for clarity).

In some embodiments, the control system 722 receives the appropriate identification code range to be used to apply a code to the mail item, receives the image, and transmits the image data to the centralized processing location that services a plurality of such imaging devices. The control system can also transmit image and identification information to the centralized data processing location, process the data using address recognition technology to resolve the address to the finest ZIP Code level, and transmit the ZIP Code and result data to the location at which the mail processing equipment is located. The control system 722 can include a communications interface 724 such as a wired or wireless network connection to transmit the data to the centralized processing location.

Apparatus 700 can also include a payment apparatus 726, connected to be controlled by the control system 722, and configured to receive payment for mailing the mailpiece. Payment apparatus 726 can be, for example, a credit or debit card scanner, coin or currency receiver, or a keyboard, touch screen, or other interface to receive payment information from the customer or an operator of the POS system, such as a clerk at a local mailing center. Apparatus 700 can include accounting software to allocate charges to the appropriate mail processing location.

Apparatus 700 can also include a geographic location receiver 728, connected to be controlled by the control system 722, that can determine the geographic location of the apparatus. Geographic location receiver 728 can be, for example, a global positioning satellite (GPS) receiver, a WiFi-based location receiver, or otherwise.

According to various embodiments, the services of data processing could be centralized and be provided to a plurality of presort bureaus. Such steps could include issuing one or more imaging/coding devices or apparatuses as described herein to presort bureaus for distribution to retail locations, providing for each device a range of parsed identification codes for use in assigning individual mail piece codes, transferring the image with its associated identification code to centralized processing facility upon assignment of an identification code to a mail item and collection of the image, processing the data and resolving the image to the delivery point level using OCR and address processing algorithms, and transmitting the results to the presort bureau to which the individual imaging/coding units have been assigned. In this case, the results go back to the presort bureau that will be gathering the data, not to the physical location where the device is receiving mail items and applying codes.

Various embodiments also include providing feedback of the address quality for single piece entry from a postal customer or clerk. These services can be integrated with any of the products identified above where there is a postal clerk or customer entering data. This feedback is provided by first analyzing the mail piece image using OCR and address processing technology, determining from the address processing whether or not the address is finalized to the finest possible delivery point, and if the address is not resolved to the finest delivery point, determining whether address elements (such as apartment number or office suite, street number, etc) are missing. This process can also include preparing a text message for display to a computer screen of the suspected problem and requesting the customer or clerk to enter clarifying information or accept the address as written. Such a computer screen can be integrated with the point of sale device or customer driven kiosk nominally designed to provide mailing services.

According to various embodiments, a local system can append weight, special service, and customer entered data to a record containing a unique identification code corresponding to the mailpiece. In some cases, a receiving party for a mail piece can be notified of an impending delivery of the mailpiece based upon the identification code. For example, a parcel, certified mail piece, registered item etc, could have that data plus customer entered phone number for the recipient and auto dialing to that party could be initiated upon receipt and processing of the item at the destination post office prior to delivery. This can warn the recipient, for example, to leave the gate open so the mail piece can be delivered, or make sure the recipient home if item is high value, etc.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A mail processing method, comprising:
receiving a mailpiece from a customer at a local system;
receiving payment information from the customer by the local system for mailing the mailpiece;
scanning the mailpiece by the local system to produce an image;
applying an identification code to the mailpiece by the local system;
after the mailpiece is delivered to a central processing facility, processing the mailpiece, using the image, by a central server system at the central processing facility.

2. The method of claim 1, wherein the local system performs an optical character recognition process on the image.

3. The method of claim 1, wherein the image is transmitted over a network from the local system to the central server system.

4. The method of claim 1, wherein the central server system performs an optical character recognition process on the image.

5. The method of claim 1, wherein local system receives information related to a desired service for the mailpiece and transmits the information to the central server system, and wherein the received payment is based on the desired service.

6. The method of claim 1, wherein the local system performs an optical character recognition process to determine a ZIP code and a delivery point bar code for the mailpiece, and transmits the ZIP code and delivery point bar code to the central server system.

7. The method of claim 1, wherein the central server system parses a set of identification codes and transmits a subset of the identification codes to each of a plurality of local systems.

8. The method of claim 1, wherein the local system is located at a post office.

9. The method of claim 1, wherein the local system is located at a private mail center.

10. The method of claim 1, wherein the local system is a kiosk operated by a customer.

11. The method of claim 1, wherein the local system appends weight, special service, and customer entered data to a record containing a unique identification code corresponding to the mailpiece.

12. The method of claim 11, wherein a receiving party for a mail piece is notified of an impending delivery of the mailpiece based upon the identification code.

13. A mail processing local system apparatus, comprising:
a transport mechanism configured to receive a mailpiece from a customer and transport the mailpiece for processing by the local system;
a payment apparatus configured to receive payment information for mailing the mailpiece;
an imaging device configured to create an image of the mailpiece;
a first printing device for applying an identification code to the mailpiece; and
a communications interface configured transmit the image of the mailpiece to a central server system.

14. The apparatus of claim 11, wherein the apparatus is configured to perform an optical character recognition process on the image.

15. The apparatus of claim 11, wherein the apparatus is configured to perform an optical character recognition process to determine a ZIP code and a delivery point bar code for the mailpiece, and transmit the ZIP code and delivery point bar code to the central server system.

16. A mail processing system, comprising:
a central server system at a central processing facility;
a plurality of mail processing local system apparatuses, each in a different geographic location, configured to communicate with the ventral server system, each mail processing local system apparatus having
a transport mechanism configured to receive a mailpiece from a customer and transport the mailpiece for processing by the local system apparatus;
at least one of a payment apparatus configured to receive payment information for mailing the mailpiece and a geographic location receiver;
an imaging device configured to create an image of the mailpiece;
a first printing device for applying an identification code to the mailpiece; and
a communications interface configured transmit the image of the mailpiece to the central server system.

17. The system of claim 16, wherein each processing local system apparatus is configured to perform an optical character recognition process on the image.

18. The system of claim 16, wherein each processing local system apparatus is configured to perform an optical character recognition process to determine a ZIP code and a delivery point bar code for the mailpiece, and transmit the ZIP code and delivery point bar code to the central server system.

19. The system of claim 16, wherein central server system is configured to perform an optical character recognition process on the image.

20. The system of claim 16, wherein one of the plurality of mail processing local system apparatuses appends weight, special service, and customer entered data to a record containing a unique identification code corresponding to the mailpiece.

21. The system of claim 20, wherein a receiving party for a mail piece is notified of an impending delivery of the mailpiece based upon the identification code.

22. A mail processing method, comprising:
receiving a mailpiece from a customer at a local system;
scanning the mailpiece by the local system to produce an image;
applying an identification code to the mailpiece by the local system;
transmitting from the local system to a central processing facility the identification code and an associated geographic reference corresponding to the location of the local system;
after the mailpiece is delivered to a central processing facility, processing the mailpiece, using the image, by a central server system at the central processing facility.

23. The method of claim 22, wherein the image is also associated with the identification code and is transmitted from the local system to the central server system.

24. The method of claim 22, wherein the local system performs an optical character recognition process to determine a ZIP code and a delivery point bar code for the mailpiece, and transmits the ZIP code and delivery point bar code to the central server system associated with the identification code.

25. The method of claim 22, wherein the local system stores weight, special service, and customer entered data in a record associated with the identification code.
